(19) United States
(12) Patent Application Publication
(10) Pub. No.: US 2005/0130602 A1
(43) Pub. Date: Jun. 16, 2005

(54) [WIRELESS TRANSMITTING/RECEIVING CIRCULATOR CIRCUIT]

(76) Inventor: Yi-Chen Guo, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/708,644

(22) Filed: Mar. 17, 2004

(30) Foreign Application Priority Data
Dec. 10, 2003 (TW) 92134784

(51) Int. Cl. H04B 1/38; H04B 1/44; H01P 1/20; H01P 3/06

(52) U.S. Cl. 455/78; 455/73

(57) ABSTRACT

A wireless transmitting/receiving circulator circuit is disclosed. The circuit comprises a first band-pass filter, a filter and a second band-pass filter. The first band-pass filter is coupled to the receiving end of a wireless device and an antenna for receiving signals from the antenna and filtering the signals to produce a receiving signal. The receiving signal is transmitted to the receiving end of the wireless device. The filter is coupled to the antenna for blocking antenna signals containing the transmitting wave band. The second band-pass filter is coupled to the transmitting end of the wireless device and the filter for receiving signals from the transmitting end and filtering the signals to produce a transmitting signal. The transmitting signal is transmitted via the antenna after passing through the filter.

### CROSS REFERENCE TO RELATED APPLICATIONS

This application claims the priority benefit of Taiwan application serial no. 92134784, filed Dec. 10, 2003.

### BACKGROUND OF INVENTION

1. Field of the Invention

The present invention relates to a wireless device. More particularly, the present invention relates to a wireless transmitting/receiving circulator circuit.

2. Description of the Related Art

In the past, communication is achieved by phones using cable connected network system. One major disadvantage of a cable network is that the communicating parties have to be station at fixed locations. In other words, portable communication is impossible using cable connected network system. With the setup of a wireless network such as a global system for mobile communication (GSM), such constraints are being eliminated.

In general, a conventional wireless device uses a switching integrated circuit (IC) as a transmission/reception interface so that channels are isolated. However, aside from a high production cost, the switching IC needs to have an external power source to power the circuit and extra external triggering leads to control its operation. Thus, using a switching IC not only increases the current loading of the wireless device but also introduces extra electrical noise during a circuit operation.

### SUMMARY OF INVENTION

Accordingly, one objective of the present invention is to provide a wireless transmitting/receiving circulator circuit for replacing a conventional switching integrated circuit (IC) so that overall production cost and current loading are reduced.

To achieve these and other advantages and in accordance with the purpose of the invention, as embodied and broadly described herein, the invention provides a wireless transmitting/receiving circulator circuit. The circulator circuit serves as a transmission/reception interface between a wireless device and an antenna such that signals at a first wave band can be received and signals at a second wave band can be transmitted. The circulator circuit comprises a first band-pass filter, a filter and a second band-pass filter. The first band-pass filter is coupled to the receiving end of a wireless device and an antenna for receiving signals from the antenna and filtering the signals to produce a receiving signal. The receiving signal is transmitted to the receiving end of the wireless device. The filter is coupled to the antenna for blocking antenna signals containing the second wave band. The second band-pass filter is coupled to the transmitting end of the wireless device and the filter for receiving signals from the transmitting end and filtering the signals to produce a transmitting signal. The transmitting signal is transmitted via the antenna after passing through the filter.

In one embodiment, the first band-pass filter of the wireless transmitting/receiving circulator circuit further comprises a low-pass filter and a high-pass filter. The low-pass filter is coupled to the antenna and the high-pass filter is coupled to the low-pass filter and the receiving end of the wireless device. Furthermore, each of the low-pass filter and the high-pass filter comprises an inductor and a capacitor. One end of the inductor of the low-pass filter is coupled to the antenna while the other end of the inductor of the low-pass filter is coupled to one end of the capacitor of the low-pass filter and one end of the capacitor of the high-pass filter. The other end of the capacitor of the low-pass filter is connected to a ground. The other end of the capacitor of the high-pass filter is coupled to one end of the inductor of the high-pass filter and the receiving end of the wireless device. The other end of the inductor of the high-pass filter is connected to the ground.

In one embodiment, the filter of the wireless transmitting/receiving circulator circuit further comprises a capacitor and an inductor. One end of the capacitor is coupled to the antenna while the other end of the capacitor is coupled to one end of the inductor. The other end of the inductor is connected to a ground.

In one embodiment, the second band-pass filter of the wireless transmitting/receiving circulator circuit further comprises a low-pass filter and a high-pass filter. The low-pass filter is coupled to the transmitting end of the wireless device. The high-pass filter is coupled to the low-pass filter and the filter. Each of the low-pass filter and the high-pass filter comprises an inductor and a capacitor. One end of the inductor of the low-pass filter is coupled to the transmitting end of the wireless device. The other end of the inductor of the low-pass filter is coupled to one end of the capacitor of the low-pass filter and one end of the capacitor of the high-pass filter. The other end of the capacitor of the low-pass filter is connected to the ground. The other end of the capacitor of the high-pass filter is coupled to one end of the inductor of the high-pass filter. The other end of the inductor of the high-pass filter is connected to the ground.

In brief, the present invention provides a wireless transmitting/receiving circulator circuit to serve as a transmission/reception interface between a wireless device and an antenna. The wireless transmitting/receiving circulator circuit is constructed using a few simple passive devices including inductors and capacitor so that overall production cost is reduced and current loading condition is improved.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The following drawings illustrate embodiments of the invention and, together with the description, serve to explain the principles of the invention.

FIG. 1 is a circuit diagram of a wireless transmitting/receiving circulator circuit according to one preferred embodiment of this invention.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

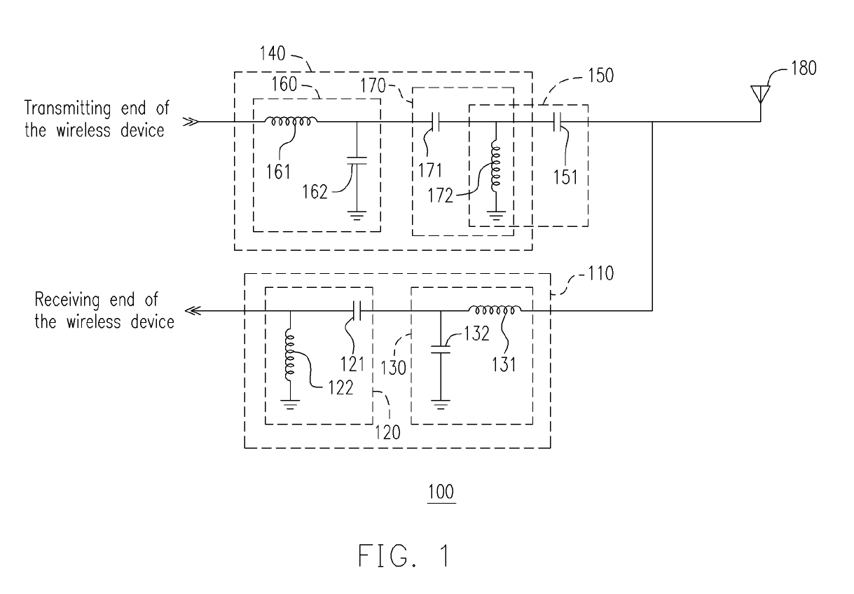

FIG. 1 is a circuit diagram of a wireless transmitting/receiving circulator circuit according to one preferred embodiment of this invention. The wireless transmitting/receiving circulator circuit 100 in FIG. 1 is a transmission/reception interface between a wireless device (not shown) such as a Global System for Mobile communication (GSM), Code Division Multiple Access (CDMA), Wide-band Code Division Multiple Access (WCDMA) and an antenna 180 for receiving signals at a first wave band and transmitting signals at a second wave band. In this embodiment, the wireless device is assumed to be a GSM system with a transmission waveband between 1710 MHz˜1785 MHz and a reception waveband between 1805 MHz˜1880 MHz.

As shown in FIG. 1, the wireless transmitting/receiving circulator circuit 100 comprises a first band-pass filter 110, a high-pass filter 150 and a second band-pass filter 140. The first band-pass filter 110 further comprises a low-pass filter 130 and a high-pass filter 120 and the second band-pass filter 140 further comprises a low-pass filter 160 and a high-pass filter 170. Furthermore, the high-pass filter 150 and the high-pass filter 170 may use a common inductor 172 to reduce the number of passive components.

The first band-pass filter 110 is coupled to the receiving end of the wireless device and the antenna 180 for receiving signals from the antenna 180 and filtering the signals to produce receiving signals falling within the 1805 MHz˜1880 MHz waveband. Thereafter, the receiving signals are transmitted to the receiving end of the wireless device. The high-pass filter 150 is coupled to the antenna 180 for blocking signals from the antenna 180 falling within the 1710 MHz˜1785 MHz waveband to prevent such signals from transmitting to the transmitting end of the wireless device and lead to interference. In other words, the high-pass filter 150 must have a cutoff frequency greater than 1785 MHz before it can block off signals falling within the 1710 MHz˜1785 MHz waveband. Here, both the high-pass filter 170 and the high-pass filter 150 use the same inductor 172 to reduce the number of passive components. Obviously, a separate inductor may be fitted inside the high-pass filter 150 so that there is no need to share the inductor 172 with the high-pass filter 170 or, alternatively, a low-pass filter may be used. When a low-pass filter is used instead of the high-pass filter 150, the cutoff frequency of the low-pass filter must be below 1710 MHz in order to block off signals falling within the 1710 MHz 1785 MHz waveband.

The second band-pass filter 140 is coupled to the transmitting end of the wireless device and the high-pass filter 150 for receiving signals from the transmitting end and filtering the signals to produce transmitting signals. The transmitting signals are transmitted via the antenna 180 after passing through the high-pass filter 150.

The first band-pass filter 110 comprises a low-pass filter 130 and a high-pass filter 120. The low-pass filter 130 further comprises an inductor 131 and a capacitor 132 and the high-pass filter 120 further comprises an inductor 122 and a capacitor 121. One end of the inductor 131 is coupled to the antenna 180 and the other end of the inductor 131 is coupled to one end of the capacitor 132 and one end of the capacitor 121. The other end of the capacitor 132 is connected to a ground. The other end of the capacitor 121 is coupled to one end of the inductor 122 and the receiving end of the wireless device. The other end of the inductor 122 is connected to the ground.

The second band-pass filter 140 comprises a low-pass filter 160 and a high-pass filter 170. The low-pass filter 160 further comprises an inductor 161 and a capacitor 162 and the high-pass filter 170 further comprises an inductor 172 and a capacitor 171. Aside from having a capacitor 151, the high-pass filter 150 also shares the inductor 172 with the high-pass filter 170. One end of the inductor 161 is coupled to the transmitting end of the wireless device while the other end of the inductor 161 is coupled to one end of the capacitor 162 and one end of the capacitor 171. The other end of the capacitor 162 is connected to a ground. The other end of the capacitor 171 is coupled to one end of the inductor 172 and one end of the capacitor 151. The other end of the inductor 172 is connected to the ground. The other end of the capacitor 151 is coupled to the antenna 180.

Although all the filters in the aforementioned wireless transmitting/receiving circulator circuit are assembled using inductors and capacitors, a combination of other passive components such as resistors and capacitors can be used and considered within the scope of the present invention.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A wireless transmitting/receiving circulator circuit serving as a signal transmission/reception interface between a wireless device and an antenna such that signals falling within a first waveband are received and signals within a second waveband are transmitted, the circulator circuit comprising:
a first band-pass filter coupled to a receiving end of the wireless device and the antenna for receiving signals from the antenna, filtering the signals to produce receiving signals and transmitting the receiving signals to the receiving end of the wireless device;
a filter coupled to the antenna for blocking signals falling within the second waveband picked up by the antenna; and
a second band-pass filter coupled to a transmitting end of the wireless device and the filter for receiving signals from the transmitting end, filtering the signals to produce transmitting signals and transmitting the transmitting signal via the antenna after passing through the filter.

2. The circulator circuit of claim 1, wherein the first band-pass filter further comprises:
a low-pass filter coupled to the antenna; and
a high-pass filter coupled to the low-pass filter and the receiving end of the wireless device.

3. The circulator circuit of claim 2, wherein the low-pass filter further comprises:
an inductor with one end coupled to the antenna; and
a capacitor with one end connected to a ground and another end coupled to another end of the inductor and the high-pass filter.

4. The circulator circuit of claim 2, wherein the high-pass filter further comprises:
a capacitor with one end coupled to the low-pass filter; and
an inductor with one end coupled to a ground and another end coupled to the other end of the capacitor and the receiving end of the wireless device.

5. The circulator circuit of claim 1, wherein the filter further comprises:
a capacitor with one end coupled to the antenna; and
an inductor with one end connected to a ground and another end coupled to the other end of the capacitor.

6. The circulator circuit of claim 1, wherein the second band-pass filter further comprises:
a low-pass filter coupled to a transmitting end of the wireless device; and
a high-pass filter coupled to the low-pass filter and the filter.

7. The circulator circuit of claim 6, wherein the low-pass filter further comprises:
an inductor with one end coupled to the transmitting end of the wireless device; and
a capacitor with one end connected to a ground and another end coupled to the other end of the inductor and the high-pass filter.

8. The circulator circuit of claim 6, wherein the high-pass filter further comprises:
a capacitor with one end coupled to the low-pass filter; and
an inductor with one end connected to a ground and another end coupled to another end of the capacitor.
